(19) United States
(12) Patent Application Publication
(10) Pub. No.: US 2005/0003864 A1
(43) Pub. Date: Jan. 6, 2005

(54) Antenna system

(76) Inventors: Robert Douglas Elliot, Naperville, IL (US); Kevin Eldon Linehan, Lemont, IL (US)

Correspondence Address: WELSH & KATZ, LTD, 120 S RIVERSIDE PLAZA, 22ND FLOOR, CHICAGO, IL, 60606, US

(21) Appl. No.: 10/613,828

(22) Filed: Jul. 3, 2003

(51) Int. Cl. H04M 1/00

(52) U.S. Cl. 455/562.1; 455/561

(57) ABSTRACT

An antenna system including a coverage antenna (2) with a coverage beam pattern; and an auxiliary antenna (3) with an auxiliary beam pattern. The auxiliary beam pattern is arranged to perform sidelobe suppression, null steering, null addition, or null-fill. In the case where the auxiliary antenna is used to perform sidelobe suppression, the auxiliary beam pattern has a mainlobe with: an amplitude lower than an amplitude of a mainlobe of said coverage beam pattern; a width lower than a width of said mainlobe of said coverage beam pattern; a phase different to a phase of a sidelobe of said coverage beam pattern; and a direction which is selected so as to at least partially suppress said sidelobe.

### FIELD OF THE INVENTION

The present invention relates to an antenna system, typically but not exclusively for use in a mobile communications wireless network.

### DESCRIPTION OF THE RELATED ART

The capacity of wireless networks is often found to be interference limited. Such interference predominantly comes from nearest neighbour cells using the same frequency. This problem is illustrated in FIG. 10, which shows a vertical section through a first base station 50 and nearest neighbour base station 51. Each base station has an antenna with a respective mainlobe 52,53, first upper sidelobes 54,55 and second upper sidelobes 56,57. At the downtilt angle shown in FIG. 10, it can be seen that the first upper sidelobes 54,55 are directed horizontally. As a result, the sidelobe 55 acts an interference source for the receive channel of the base station 50, and the sidelobe 54 acts an interference source for the receive channel of the base station 51. Similarly, the second upper sidelobes 56,57 can act as interference sources for larger angles of downtilt.

A conventional method of sidelobe suppression is described in US6140974. An auxiliary antenna is provided adjacent to a main antenna. The auxiliary antenna has a radiation pattern with sidelobes but with a reduced front lobe component. By subtracting this auxiliary antenna mask or pattern from that of the main antenna, the main antenna side lobes are cancelled leaving only the front lobe as required. A problem with this approach is that the sidelobes will not be perfectly cancelled. Also, it is not possible to produce an auxiliary antenna pattern with no main lobe, so this will partially cancel the main lobe of the main antenna.

An auxiliary antenna can also be used to provide adaptive cancellation of fixed interferers, as described for instance in US2002/0002065 A1.

An alternative method of sidelobe suppression is described in US2002/0006374 A1. Phase control circuitry sets the phase of signals fed to and/or received by each element of an array of antenna elements. The phase of each element is set as a function of position to generate an asymmetric side-lobe pattern, wherein sidelobes on at least one side of a principal lobe are suppressed. The problem with phased array techniques such as this is that there are inevitable trade-offs. In particular, the suppression of one side lobe may result in enhancing another side lobe.

### BRIEF DESCRIPTION OF EXEMPLARY EMBODIMENT

The exemplary embodiment provides, in a first aspect, an antenna system including a coverage antenna with a coverage beam pattern; and an auxiliary antenna with an auxiliary beam pattern, wherein said auxiliary beam pattern has a mainlobe with:
a) an amplitude lower than an amplitude of a mainlobe of said coverage beam pattern;
b) a width lower than a width of said mainlobe of said coverage beam pattern;
c) a phase substantially opposite to a phase of a sidelobe of said coverage beam pattern; and
d) a direction which is selected so as to at least partially suppress said sidelobe.

The exemplary embodiment provides, in a second aspect, an antenna system including a coverage antenna with a coverage beam pattern; an auxiliary antenna with an auxiliary beam pattern having a mainlobe with an amplitude, width, and direction selected so as to modify said coverage beam pattern; and a transmit/receive system for receiving uplink signals from said antennas and transmitting downlink signals to said antennas.

Prior art use of auxiliary antennas has previously been limited to systems which are either operable in a receive mode, or in a transmit mode, but not in both. We have recognised the benefits of an auxiliary antenna in a system which is operable in both a receive mode and a transmit mode, particularly in a network having adjacent co-frequency antenna systems which can act as interference sources. The transmit and receive modes may operate simultaneously (in the case of a frequency or code division multiplexed system) or at different times (in the case of a time division multiplexed system).

The auxiliary antenna may perform one of a number of different beam modification functions, including but not limited to sidelobe suppression, adjusting the position of one or more existing nulls in the coverage beam pattern, establishing additional nulls in the coverage beam pattern, or-performing null-fill.

### BRIEF DESCRIPTION OF THE DRAWINGS

Illustrative embodiments of the invention will now be described with reference to the accompanying drawings to disclose the advantageous teachings of the present invention.

FIG. 1 shows a single polarized antenna system according to the present invention;

FIG. 2 shows the elevation beam pattern associated with the coverage antenna only, with 0.0 degrees downtilt;

FIG. 3 shows the elevation beam pattern associated with the coverage antenna only, with 12.7 degrees downtilt;

FIGS. 4-9 show modified elevation beam patterns;

FIG. 10 shows a conventional mobile communications wireless network;

FIG. 11 shows a mobile communications wireless network according to the present invention;

FIG. 12 shows a dual polarized antenna system according to the present invention;

FIG. 13 is a schematic end view of the system of FIG. 12; and

FIG. 14 illustrates null fill of the null between a mainlobe and first lower sidelobe.

### DETAILED DESCRIPTION OF EMBODIMENTS OF THE INVENTION

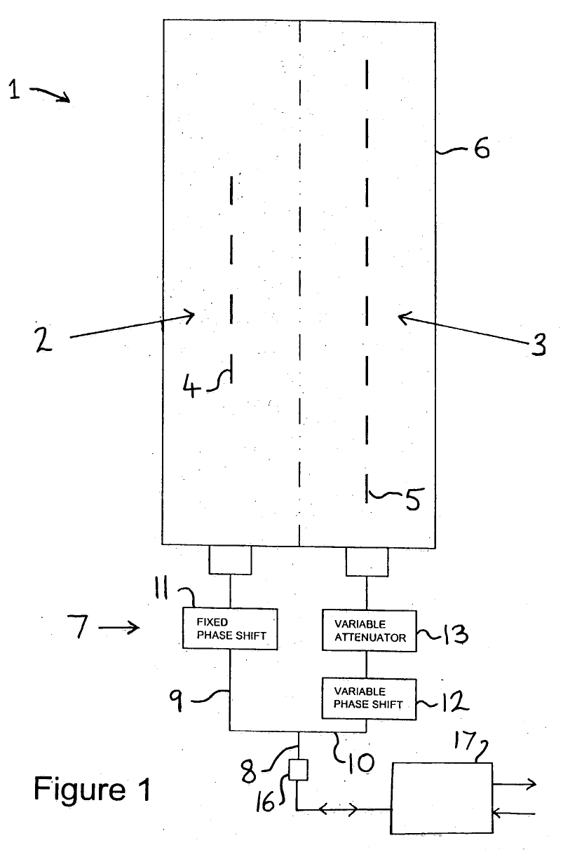

Referring to FIG. 1, a single polarized antenna system 1 comprises a coverage antenna 2 and an auxiliary antenna 3. The coverage antenna comprises a vertical line of four vertically oriented dipoles 4, and the auxiliary antenna comprises a vertical line of eight vertically oriented dipoles 5 arranged parallel with, and to one side of the dipoles 4. Only the lowest dipoles in the two antennas are labelled 4,5.

The dipoles are mounted on a panel 6 which acts as a back reflector and also as an RF ground plane. The dipoles and panel 6 are enclosed in a single radome (not shown). The package width is approximately 300 mm. Other package widths may be employed, depending on the wavelength of operation.

The antennas 2,3 are driven by a feed network 7 including a main feedline 8, coverage antenna feedline 9 and auxiliary antenna feedline 10 which meet the main feedline 8 at a junction. A fixed phase shifter 11 is incorporated into the coverage antenna feedline 9. This compensates for the fact that the length between the main feedline 8 and the coverage antenna 2 is greater than the length between the main feedline 8 and the auxiliary antenna 3 (due to the greater length of the auxiliary antenna 3). That is, the fixed phased shifter 11 brings the lowest dipole 4 into phase with the lowest dipole 5. A variable phase shifter 12 and variable attenuator 13 are built into the auxiliary antenna feedline 10.

A variety of attenuators may be used. Preferably, the attenuator is a motorized electromechanical attenuator which adjusts power by relatively moving components of the attenuator. One example is a rotary vane attenuator. By way of example, a motorized variable coaxial attenuator may be employed such as the Model 9026-3 or Model 9026-4 supplied by Waveline Inc., of West Caldwell, N.J. These models only have average power ratings of 10 W, so are only suitable for low power applications. An alternative is the 8310 series attenuator supplied by Weinschel Corp., of Frederick, Md., which employs GaAs FET or PIN solid-state attenuators.

Downtilt of the coverage antenna 2 can be adjusted electrically by a downtilt phase shifting network (not shown) which adjusts the relative phase between the dipoles 4. Similarly, downtilt of the auxiliary antenna 3 can be adjusted independently of the coverage antenna 2 by a downtilt phase shifting network (not shown). Suitable motorized phase shifter arrangements are described in US6198458 and WO 02/067374 A1, the disclosures of which are incorporated herein by reference.

The variable phase shifter 12 is typically also a motorized electromechanical phase shifter of the type shown in US6198458 and WO 02/067374 A1.

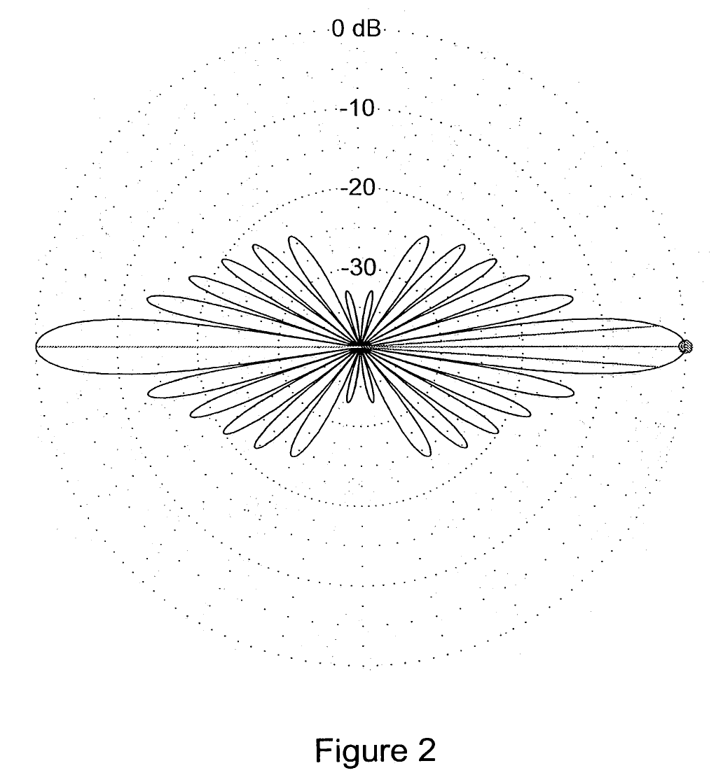

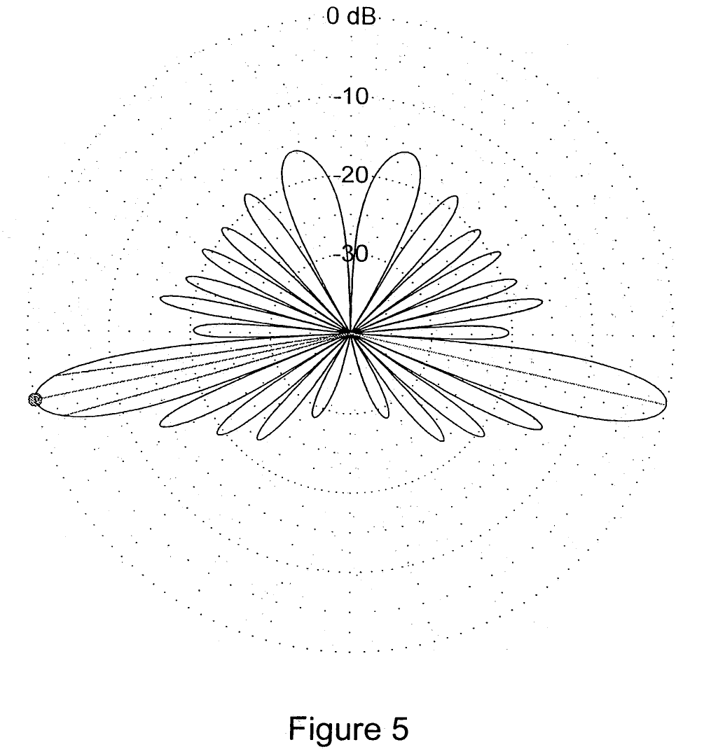

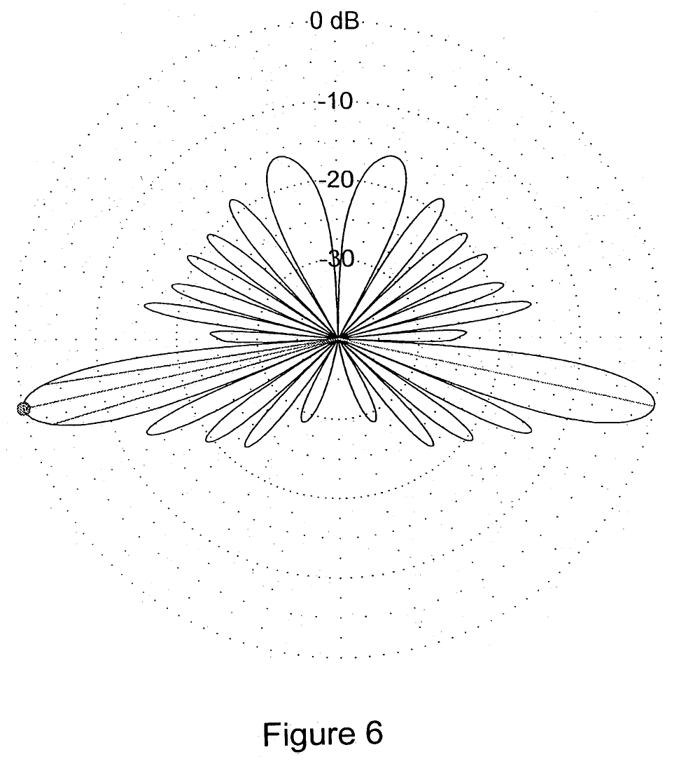

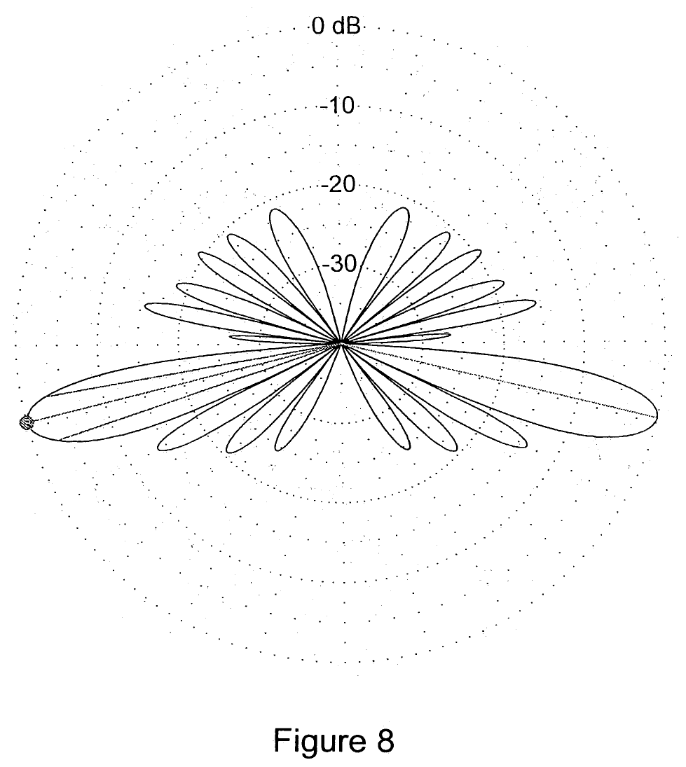

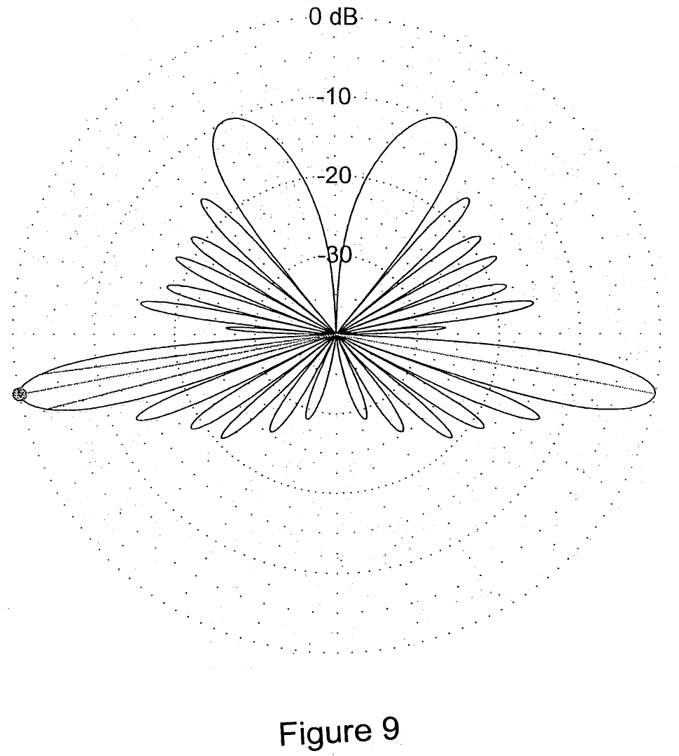

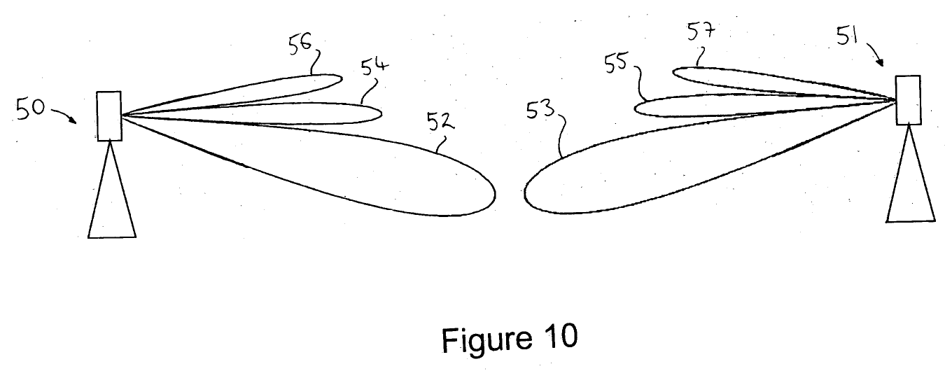

A set of computer simulated beam patterns are shown in FIGS. 2-9. The beam patterns are calculated for an antenna system similar to the antenna system 1, but with auxiliary and coverage antennas having sixteen and eight dipoles respectively. The patterns are in the vertical (elevation) plane. FIGS. 2-7 show the beam patterns at a frequency of 299.793 MHz, FIG. 8 at 264.25 MHz and FIG. 9 at 335.3 MHz. Since the patterns are generated by computer simulation, they are the same in both forward and reverse directions. However it will be appreciated that in practice the beam patterns will be suppressed in the reverse direction due to the reflective properties of the panel 6. The frequencies given are by way of example only, and in practice any frequency range may be employed. Preferred frequency ranges include the cellular, PCS or UMTS frequency bands.

FIG. 2 shows the beam pattern associated with the coverage antenna only, with 0.0 degrees downtilt. The pattern includes a mainlobe at 0.0 degrees, six upper sidelobes at various elevation angles, and six equivalent lower sidelobes.

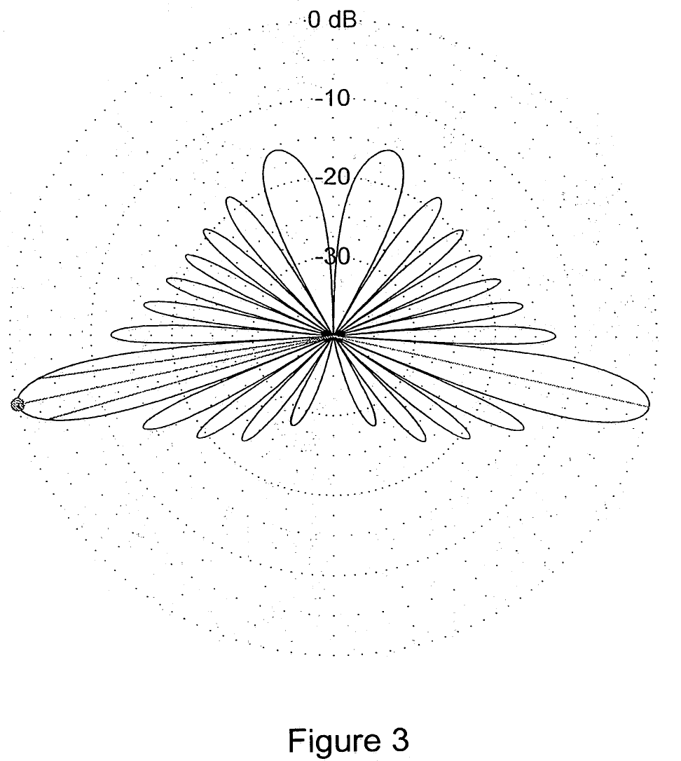

FIG. 3 shows the coverage antenna beam pattern with 12.7 degrees downtilt. At this downtilt angle, it can be seen that the first upper sidelobe lies on the horizon (that is, at 0.0 degrees).

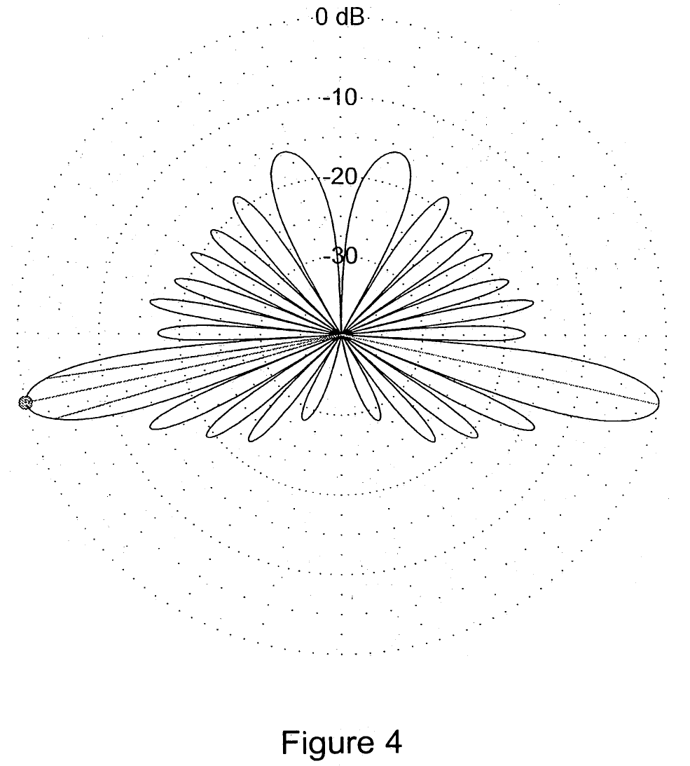

FIGS. 4-7 show modified coverage beam patterns with the variable attenuator 13 set so that the radiating elements of the auxiliary antenna are fed with voltage at 5%, 7%, 9% and 11% respectively of the voltage of the coverage antenna. The downtilt of the auxiliary antenna is set by the downtilt network so that the mainlobe of the auxiliary antenna is at 0.0 degrees downtilt, aligned with the first upper sidelobe of the coverage antenna. The phase of the auxiliary antenna is set by variable phase shifter 12 to be approximately in antiphase with the first upper sidelobe of the coverage antenna. By comparison With FIG. 3, it can be seen that the first upper sidelobe is progressively reduced from FIG. 4 to FIG. 7, as the amplitude of the mainlobe of the auxiliary antenna approaches the amplitude of the first upper sidelobe of the coverage antenna.

In the preferred case, the phase of the auxiliary antenna is set as close as possible to be in antiphase with the first upper sidelobe of the coverage antenna. However, in practice it is expected that the phase difference may be set up to 1/16^{th} of a wavelength away from precise antiphase, and still give useful results.

That is, the phase difference between the coverage and auxiliary antenna typically lies between 157.5° and 202.5°.

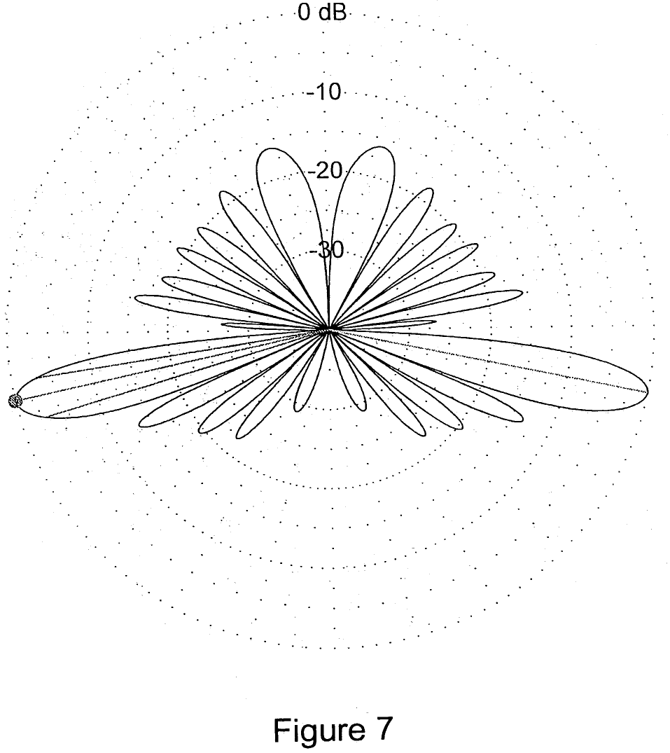

FIG. 8 shows a modified beam pattern with the auxiliary antenna fed with voltage at 11% of the voltage of the coverage antenna, at a frequency of 264.25 MHz. The sixth upper sidelobe is reduced compared to the sixth upper sidelobe in FIG. 7.

FIG. 9 shows a modified beam pattern with the auxiliary antenna fed with voltage at 11% of the voltage of the coverage antenna, at a frequency of 335.3 MHz. The sixth upper sidelobe is increased compared to the sixth upper sidelobe in FIGS. 7 and 8.

It will be appreciated that the system effectively acts as an inteferometer. This is exploited in the vertical plane to achieve sidelobe suppression. However, the interferometer also acts in the horizontal plane. This is not seen to be a problem since the coverage and auxiliary antennas are typically less than one wavelength apart and the auxiliary antenna is fed typically 13 to 18 dB down from the coverage antenna (note that the auxiliary antenna has 3 dB more gain than the coverage antenna). The distortion to the azimuth pattern is therefore expected to be minor. It is believed that the spacing between the antennas could be increased up to a maximum of approximately 1.3 λ.

The antenna system 1 could be constructed as a variant of an existing dual band base station antenna, where the two frequency bands are one and the same (such as the Andrew Corporation ADFD1820-6565B-XDM). Specifically, one of the 16 dBd gain arrays of the ADFD1820-6565B-XDM can be replaced by a 13 dBd array (for the coverage antenna) and the remaining 16 dBd array would constitute the auxiliary antenna.

The auxiliary antenna is directed at the appropriate downtilt angle and fed at the appropriate phase and amplitude such that the mainlobe of the auxiliary antenna at least partially cancels out the first upper sidelobe of the coverage antenna. The width (in the elevation plane) of the auxiliary beam is narrower than the width of the coverage beam due to the greater length of the auxiliary antenna. By making the auxiliary antenna twice as long as the coverage antenna (that is, by using twice as many radiating elements with the same inter-element spacing), it has been determined that the mainlobe of the auxiliary antenna approximates to the width of the first upper sidelobe of the coverage antenna (as required for cancellation of the first upper sidelobe). Length ratios other than 2:1 may be employed for other applications (such as null steering or null-fill), but for sidelobe suppression it is believed that the 2:1 ratio is optimal. If required, the phase, amplitude and direction of the auxiliary antenna can be adjusted to suppress one of the other five sidelobes. Note that the azimuth beamwidth of the auxiliary antenna and the coverage antenna are substantially identical.

It is considered that the disadvantages associated with the larger height of the antenna system (due to the height of the auxiliary antenna) will be more than off-set by the improved performance in carrier to interference ratio, and subsequent improvement in capacity.

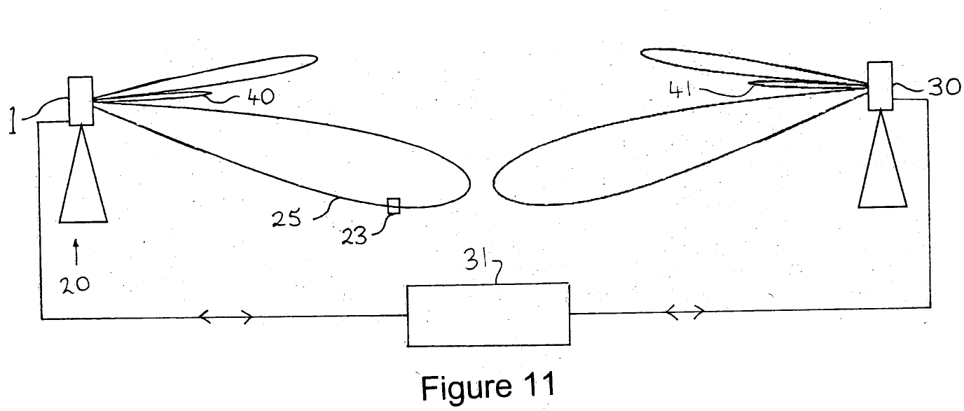

The system 1 is shown in use in a base station 20 of a mobile communications wireless network shown in FIG. 11. The system 1 is used in a conventional fashion to provide coverage for a cell via downtilted mainlobe 25. That is, the antenna transmits downlink signals to one or more mobile wireless devices 23 in the cell, and receives uplink signals from the same device(s). Referring to FIG. 1—the feed network 7 is connected via an input port 16 to a transmit/receive system 17 including a Frequency Division Duplexer (FDD) which transmits the downlink signals at a first frequency and receives the uplink signals at a second frequency.

Returning to FIG. 11: an adjacent antenna system 30 services an adjacent cell and operates in the same frequency band as the system 1. The antenna systems 1,30 are connected to a common network controller 31 (which is also connected to all other base stations making up the network). The network may operate according to CDMA, GSM, PCS or any other network protocol.

Suppression of the first upper sidelobe 40 of the transmit beam pattern of the antenna system 1 reduces the interference of the system 1 with the adjacent system 30. Equivalently, suppression of the first upper sidelobe 40 of the receive beam pattern of the antenna system 1 reduces the sensitivity of the system 1 to interference from the adjacent system 30. The same is true for the suppressed first upper sidelobe 41 of the system 30.

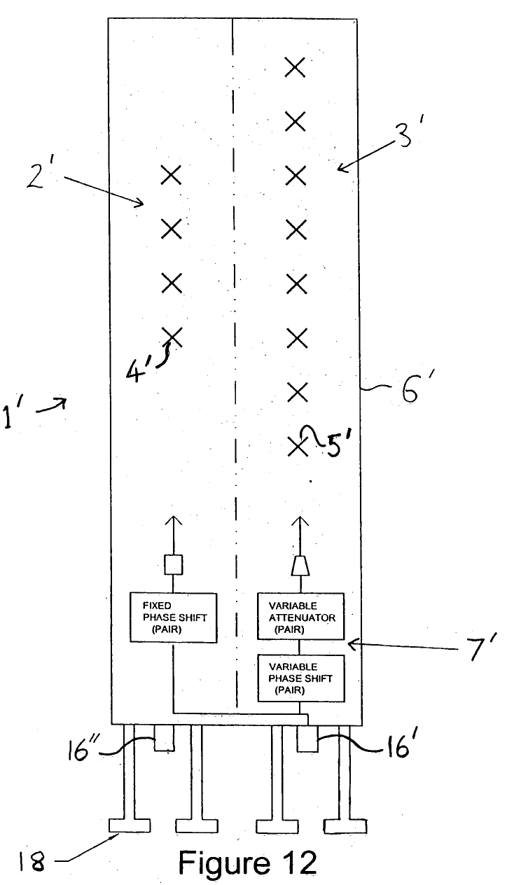

An alternative, dual-polarized, antenna system 1′ is shown in FIG. 12. The system works along similar principles to the system 1 of FIG. 1, but in a dual-polarized mode. The coverage antenna 2′ and auxiliary antenna 3′ comprise crossed dipoles 4′,5′ with one dipole at +45 degrees to the vertical and the other dipole at −45 degrees to the vertical. The +45 dipoles are driven by a feed network 7′ with input port 16′. The feed network 7′ is identical to the feed network 7. The −45 dipoles are driven by a separate feed network (not shown) with an input port 16″.

FIG. 12 shows four motorized actuators 18 for controlling the four variables (that is, auxiliary beam strength, auxiliary beam phase, auxiliary beam downtilt, and coverage beam downtilt). Equivalent actuators are also used in the system of FIG. 1, but are omitted from FIG. 1 for clarity. A suitable actuator is the ATM100-001 motorized actuator supplied by Andrew Corporation, of Orland Park, Ill. The actuators 18 are remotely controlled by a central controller (not shown), as described in detail in WO 02/067374 A1, the disclosure of which is incorporated herein by reference.

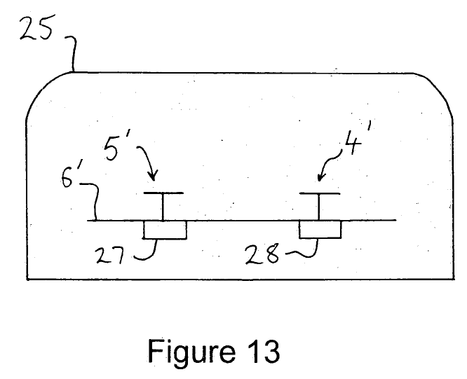

FIG. 13 is an end view of the antenna. The coverage antenna and nulling antenna are housed in a common radome 25 above a reflective ground plane 6′. Downtilt phase shifters 27,28 are also shown schematically in FIG. 13, mounted to the reverse of the ground plane 6′.

Although the preferred embodiments described above employ dipole elements, patch radiating elements, or other radiating elements may be employed instead.

Although the auxiliary antenna in the preferred embodiments discussed above suppress the first upper sidelobe, it will be appreciated that the auxiliary antenna could be set to suppress other sidelobes. For instance the auxiliary antenna could be set to suppress the first lower sidelobe. This may be of benefit in countries (for instance in Europe) which have tight regulations against radiation emissions being directed downwards towards the population.

Instead of being used to suppress one of the sidelobes of the coverage antenna, the auxiliary antenna may be used to provide null steering of the coverage beam pattern. That is, the direction, phase and amplitude of the auxiliary beam can be adjusted so as to adjust the position of a null in the coverage beam pattern. For instance, the mainlobe of the auxiliary antenna may be directed towards the region of the first null of the coverage beam pattern (that is, the null between the mainlobe and first sidelobe). This enables the position of the first null to be altered.

In a further alternative, the auxiliary antenna may be employed to insert an additional null in the coverage beam pattern. For instance, a null may be directed towards a known interference source.

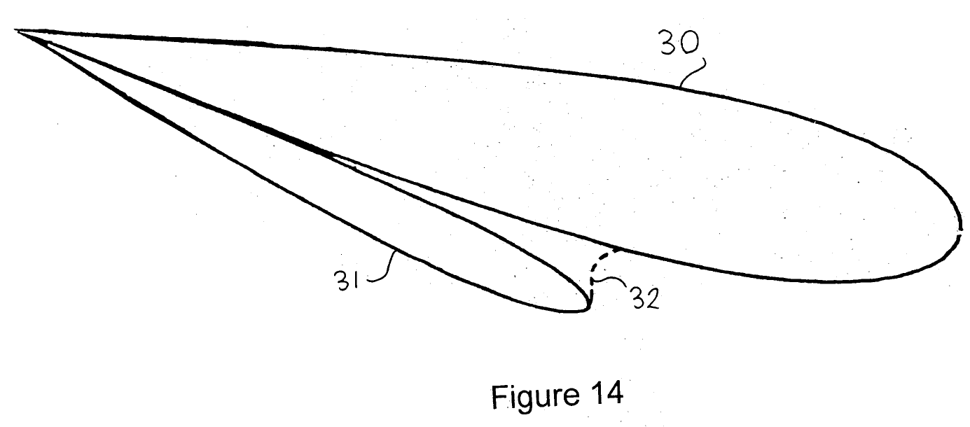

In yet a further alternative, the auxiliary antenna may be employed to perform a null-filling function, as described in FIG. 14. FIG. 14 shows a coverage pattern in solid lines, including a main lobe 30, and a first lower sidelobe 31. A deep null exists between the two lobes. The auxiliary antenna may be employed to fill the null between the lobes, producing a modified beam pattern as shown by dashed line 32. In this case the phase relationship between the auxiliary antenna and the coverage antenna is unimportant, since the amplitude of the auxiliary antenna at the critical angle is dominant over the pattern level of the coverage antenna.

Although the antennas discussed above employ only a single auxiliary antenna, it will be appreciated that multiple auxiliary antennas may be employed. For instance a first auxiliary antenna may be used for suppressing the first upper sidelobe and a second auxiliary antenna for suppressing the first lower sidelobe. In addition a third auxiliary antenna may be used to null the second upper sidelobe, etc. The auxiliary antennas are simply stacked side by side. The antennas may all be housed in a common radome, or may have separate radomes butted together.

The embodiment described above employ a panel 6 which acts as a back reflector and also as an RF ground plane. As an alternative, the antennas may employ directional radiating elements not requiring a ground plane/back reflector. An example of a suitable directional antenna is a Yagi array.

The variable attenuators and variable phase shifters described above employ remotely controlled motorized actuators. However, in an alternative embodiment, the actuators may be manually adjustable.

Typically the actuators and control system for the variable attenuators and variable phase shifters are field retrofittable.

The attenuators and phase shifters described above are variable, but in an alternative embodiment, the attenuators and phase shifters may be fixed at a set level.

Although the preferred embodiments described above employ an FDD, in an alternative a Time Division Duplexer (TDD) may be employed which uses the same frequency in the transmit and receive directions.

The present invention has been described herein with reference to particular embodiments for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. An antenna system including a coverage antenna with a coverage beam pattern; and an auxiliary antenna with an auxiliary beam pattern, wherein said auxiliary beam pattern has a mainlobe with:
a) an amplitude lower than an amplitude of a mainlobe of said coverage beam pattern;
b) a width lower than a width of said mainlobe of said coverage beam pattern;
c) a phase different to a phase of a sidelobe of said coverage beam pattern; and
d) a direction which is selected so as to at least partially suppress said sidelobe.

2. An antenna system according to claim 1 wherein said width of said mainlobe of said auxiliary beam pattern is substantially equal to a width of said sidelobe.

3. An antenna system according to claim 1 wherein the phase difference between said mainlobe of said auxiliary beam pattern and said sidelobe of said coverage beam pattern lies in the range 157.5° to 202.5°.

4. An antenna system according to claim 1 wherein said direction of said mainlobe of said auxiliary beam pattern is substantially aligned with said direction of said sidelobe.

5. An antenna system according to claim 1 wherein said antenna system is operable in a receive mode.

6. An antenna system according to claim 1 wherein said antenna system is operable in a transmit mode.

7. An antenna system according to claim 1 wherein said antenna system is operable in a receive mode and in a transmit mode.

8. An antenna system according to claim 7 wherein said system receives signals at a first frequency in said receive mode, and transmits signals at a second frequency in said transmit mode.

9. An antenna system according to claim 1 including a variable phase shifter for varying said phase of said mainlobe of said auxiliary beam pattern.

10. An antenna system according to claim 1 including an attenuator for lowering said amplitude of said mainlobe of said auxiliary beam pattern.

11. An antenna system according to claim 10 wherein said attenuator is a motorized electromechanical attenuator.

12. An antenna system according to claim 1 wherein said coverage antenna has a smaller length than said auxiliary antenna.

13. An antenna system according to claim 1 wherein said coverage antenna has a smaller number of antenna elements than said auxiliary antenna.

14. An antenna system according to claim 1 wherein said mainlobe of said auxiliary beam pattern has a width in a vertical plane which is lower than a width of said mainlobe of said coverage beam pattern in a vertical plane.

15. An antenna system according to claim 1 wherein said mainlobe of said coverage beam is downwardly downtilted.

16. An antenna system according to claim 1 wherein a downtilt angle of said mainlobe of said auxiliary beam pattern is different to a downtilt angle of said mainlobe of said coverage beam pattern.

17. An antenna system according to claim 16 wherein said downtilt angle of said mainlobe of said auxiliary beam pattern is lower than said downtilt angle of said mainlobe of said coverage beam pattern.

18. An antenna system according to claim 1 including a phase shifter for electrically steering said auxiliary beam pattern.

19. An antenna system according to claim 1 wherein said antenna system is configured to operate at a selected wavelength λ, and the spacing between said coverage antenna and said auxiliary antenna is less than 1.3 λ.

20. An antenna system according to claim 19 wherein the spacing between said coverage antenna and said auxiliary antenna is less than 1.0 λ.

21. An antenna system according to claim 1 including a substantially planar reflector for reflecting radiation to and/or from said coverage antenna.

22. An antenna system according to claim 1 including a substantially planar reflector for reflecting radiation to and/or from said auxiliary antenna.

23. An antenna system according to claim 22 wherein said substantially planar reflector also reflects radiation to and/or from said coverage antenna.

24. A mobile communications wireless network including two or more antenna systems according to claim 1, each system being arranged to communicate with mobile devices in a respective coverage area; and a network controller coupled to said antenna systems.

25. An antenna system including a coverage antenna with a coverage beam pattern; an auxiliary antenna with an auxiliary beam pattern having a mainlobe with an amplitude, width, and direction selected so as to modify said coverage beam pattern; and a transmit/receive system for receiving uplink signals from said antennas and transmitting downlink signals to said antennas.

26. An antenna system according to claim 25 wherein said auxiliary beam pattern has a mainlobe with a width lower than a width of a mainlobe of said coverage beam pattern.

27. An antenna system according to claim 25 wherein said transmit/receive system receives signals at a first frequency in said receive mode, and transmits signals at a second frequency in said transmit mode.

28. An antenna system according to claim 25 wherein a mainlobe of said auxiliary beam pattern is directed so as to adjust the position of a null of said coverage beam pattern.

29. An antenna system according to claim 25 wherein a mainlobe of said auxiliary beam pattern is directed so as to null-fill said coverage beam pattern.

30. An antenna system according to claim 25 wherein the auxiliary beam pattern has a phase selected so as to modify said coverage beam pattern.

31. An antenna system according to claim 30 including a variable phase shifter for varying a phase of said auxiliary antenna.

32. An antenna system according to claim 25 including an attenuator for lowering an amplitude of said auxiliary beam pattern.

33. An antenna system according to claim 32 wherein said attenuator is a motorized electromechanical attenuator.

34. An antenna system according to claim 25 wherein said coverage antenna has a smaller length than said auxiliary antenna.

35. An antenna system according to claim 25 wherein said coverage antenna has a smaller number of antenna elements than said auxiliary antenna.

36. An antenna system according to claim 25 wherein a mainlobe of said auxiliary beam pattern has a width in a vertical plane which is lower than a width of a mainlobe of said coverage beam pattern in a vertical plane.

37. An antenna system according to claim 25 wherein a mainlobe of said coverage beam is downwardly downtilted.

38. An antenna system according to claim 25 wherein a downtilt angle of a mainlobe of said auxiliary beam pattern is different to a downtilt angle of a mainlobe of said coverage beam pattern.

39. An antenna system according to claim 38 wherein said downtilt angle of said mainlobe of said auxiliary beam pattern is lower than said downtilt angle of said mainlobe of said coverage beam pattern.

40. An antenna system according to claim 25 including a phase shifter for electrically steering said auxiliary beam pattern.

41. An antenna system according to claim 25 wherein said antenna system is configured to operate at a selected wavelength λ, and the spacing between said coverage antenna and said auxiliary antenna is less than 1.3 λ.

42. An antenna system according to claim 41 wherein the spacing between said coverage antenna and said auxiliary antenna is less than 1.0 λ.

43. An antenna system according to claim 25 including a substantially planar reflector for reflecting radiation to and/or from said coverage antenna.

44. An antenna system according to claim 25 including a substantially planar reflector for reflecting radiation to and/or from said auxiliary antenna.

45. An antenna system according to claim 44 wherein said substantially planar reflector also reflects radiation to and/or from said coverage antenna.

46. A mobile communications wireless network including two or more antenna systems according to claim 25, each system being arranged to communicate with mobile devices in a respective coverage area; and a network controller coupled to said antenna systems.
